(19) United States
(12) Patent Application Publication
(10) Pub. No.: US 2026/0138544 A1
(43) Pub. Date: May 21, 2026

(54) METHOD FOR PERSONALIZING A MOTOR VEHICLE, ASSOCIATED COMPUTER PROGRAM, ELECTRONIC DEVICE FOR PERSONALIZING A MOTOR VEHICLE AND ASSEMBLY COMPRISING SUCH A DEVICE

(71) Applicant: Faurecia Clarion Electronics Europe, Paris (FR)

(72) Inventor: Julien RICHEFEU, Paris (FR)

(21) Appl. No.: 19/331,926

(22) Filed: Sep. 17, 2025

(30) Foreign Application Priority Data
Sep. 17, 2024 (FR) FR 24 09848

(51) Int. Cl. B60R 16/023; H04L 67/12; H04W 4/48

(52) U.S. Cl. CPC B60R 16/0231; H04L 67/12; H04W 4/48

(57) ABSTRACT

An electronic personalization device and method for personalization of a vehicle that has a cockpit domain controller configured to identify a user of the vehicle, connect to an item of user equipment and collect social network data of the user. The method carried out by the device includes: a step for the cockpit domain controller to acquire social network data associated with a respective user; a step for building a model of a user profile, known as a user model, from the social network data associated with the user; and a step for transmitting the user model to at least one item of on-board electronic equipment in the vehicle, so that the on-board electronic equipment can perform an action dependent on the user model.

### TECHNICAL FIELD

The present invention relates to a method for personalizing a motor vehicle, implemented by an electronic personalization device. It also relates to a computer program for implementing such a personalization method, as well as to such an electronic personalization device for a motor vehicle, and to an assembly comprising such a personalization device.

### BACKGROUND

Devices integrated into electric vehicles are known to provide recommendations based on data collected from an item of user equipment.

However, these recommendations are limited to specific applications, such as in-vehicle infotainment. Other automotive transport issues, such as improving safety, are not addressed by these applications.

### SUMMARY

An aim of the invention is then to provide a method for personalizing a motor vehicle, allowing new applications linked to driving the vehicle, in particular to improve on-board safety of the vehicle.

To this end, the invention relates to a method of personalizing a motor vehicle, implemented by an electronic personalization device for the vehicle intended to be carried on board the motor vehicle, the vehicle comprising a cockpit domain controller configured to identify a user of the vehicle, connect to an item of user equipment and collect social network data from the user, the method comprising:

a step for the cockpit domain controller to acquire social network data associated with a respective user;

a step for building a model of a user profile, known as a user model, from the social network data associated with said user; and

a step for transmitting the user model to at least one item of on-board electronic equipment in the vehicle, so that the on-board electronic equipment can perform an action dependent on the user model.

By virtue of the invention, the data collected are used to build a user model for use by a wide variety of on-board electronic equipment items in the vehicle, notably driving and navigation systems.

Additionally, the development of the user model eliminates the need to store social network data, thereby optimizing data storage and confidentiality.

According to other advantageous aspects of the invention, the personalization method comprises one or more of the following features, taken alone or in any technically feasible combination:

the social network data comprise one or more data from the group comprising:

a list of social networks frequently used by the user;

a history of actions carried out by the user on each social network;

keywords associated with content consulted by the user on each social network;

a history of the user's usage time ranges of each social network;

a language for using at least one social network; and

a user's location when using at least one social network;

the user model does not contain social network data and is stored in a memory intended for use in the vehicle only;

the building step is carried out using an artificial intelligence algorithm;

the artificial intelligence algorithm has a transformer-type architecture;

the building step includes determining a social group of the user based on social network data and data fusion recommendations from the relevant social networks.

The invention also relates to a non-transitory computer-readable medium storing instructions which, when executed by one or more processors, cause the one or more processors to perform a personalization method as defined above.

The invention also relates to an electronic personalization device for a motor vehicle intended to be carried on board the motor vehicle, the vehicle comprising a cockpit domain controller configured to identify a user of the vehicle, connect to an item of user equipment and collect social network data from the user, the electronic device comprising:

a module for the cockpit domain controller to acquire social network data associated with a respective user;

a module for building a model of a user profile, known as a user model, from the social network data associated with said user; and

a module for transmitting the user model to at least one item of on-board electronic equipment in the vehicle, so that the on-board electronic equipment can perform an action dependent on the user model.

The invention also relates to an assembly comprising:

a cockpit domain controller configured to identify a user, connect to an item of user equipment and collect the social network data of the user;

an electronic personalization device according to the preceding claim; and

at least one item of on-board electronic equipment, configured to receive the user model transmitted by the electronic personalization device and to implement an action dependent on said user model.

According to another advantageous aspect of the invention, the assembly is such that the at least one item of on-board equipment is selected from the group including:

the cockpit domain controller, configured to deliver information or a recommendation to the user relating to driving the vehicle or using an on-board equipment item, depending on the user model;

an equipment controller configured to control the activation of one or more other items of equipment, such as headlights or windshield wipers; and

an emotion(s) detector, configured to detect at least one user emotion using a context provided by the user model and to generate a control signal for another equipment item based on the detected emotion.

### BRIEF DESCRIPTION OF THE DRAWINGS

The invention will become clearer on reading the following description, given solely by way of non-limiting example, and made with reference to the drawings, wherein:

FIG. 1 is a schematic view of a motor vehicle comprising an electronic personalization device according to an embodiment of the invention; and

FIG. 2 is a schematic diagram of a method, according to an embodiment of the invention, for personalizing a motor vehicle, implemented by the electronic personalization device shown in FIG. 1.

### DETAILED DESCRIPTION

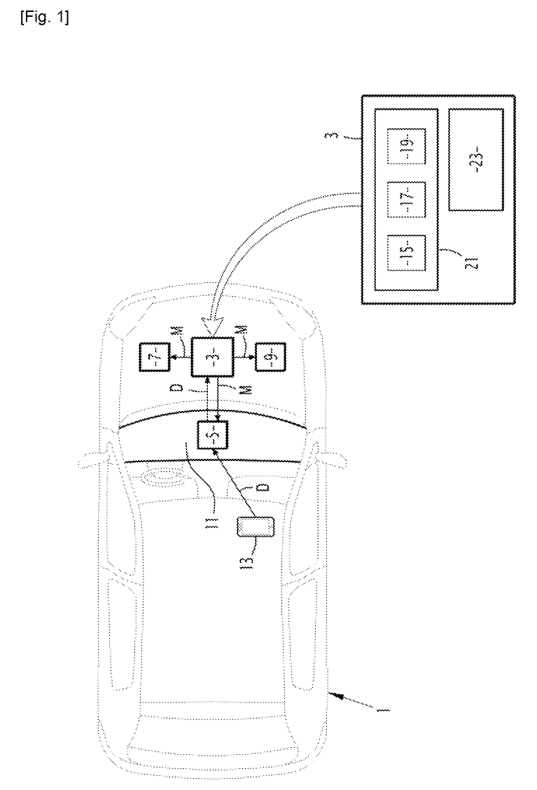

In FIG. 1, a motor vehicle 1 comprises an electronic personalization device 3 and on-board electronic equipment items 5, 7 and 9. One of the on-board electronic items is a cockpit domain controller 5, for example located in an instrument panel 11 at the front of the motor vehicle 1, proximate to a driver of the vehicle 1. In addition or alternatively, the on-board electronic equipment item is an equipment controller 7, or an emotion detector 9.

The cockpit domain controller 5 is configured to control a set of infotainment functions within a cockpit of the vehicle 1. Additionally, the cockpit domain controller 5 is configured to connect to a user equipment item 13, for example a smartphone, belonging to a user of the vehicle 1. In particular, the user uses the user equipment item 13 to browse social networks, which generates social network data D, stored on the user equipment item 13 and/or on a social network to which the user equipment item 13 is advantageously connected. Once connected to the user equipment item 13, the cockpit domain controller 5 is further configured to collect the social network data D of the user.

As shown in FIG. 1, the electronic personalization device 3 comprises an interface for acquiring data from the cockpit domain controller 5 and interfaces for transmitting data to the on-board electronic equipment items 5, 7 and 9, respectively. The electronic personalization device 3 comprises an acquisition module 15, a building module 17 and a transmission module 19.

The acquisition module 15 is configured to acquire, from the cockpit domain controller 5, the social network data D associated with the user whose user equipment item 13 is connected to the cockpit domain controller 5. This acquisition is carried out via the aforementioned acquisition interface.

The social network data represent the user's usage habits on social networks, as well as the tasks carried out by the user on these networks. In particular, the social network data comprise one or more data from the group comprising:

a list of social networks frequently used by the user;

a history of actions carried out by the user on each social network;

keywords associated with content consulted by the user on each social network;

a history of the user's usage time ranges of each social network;

a language for using at least one social network; and

user location when using at least one social network.

The building module 17 is configured to build a model of a user profile, known as a user model M, from the social network data D associated with said above-mentioned. "Building a model" is understood to mean both the construction of a new model, that is, building a model ex nihilo, and the enhancement of a pre-existing model.

The user model M represents a social profile of the user. In particular, the user model M represents the social habits of the user, while making it possible not to store social network data D per se. This solves data confidentiality issues that would otherwise arise from storing social network data D.

Additionally, the social network data D is preferably anonymized by the acquisition module 15 or by the building module 17. Advantageously, the user model M also represents a social group of the user, obtained from social network data D and data fusion recommendations from the relevant social networks.

Advantageously, the building module 17 is configured to build the user model M by implementing an artificial intelligence algorithm. The artificial intelligence algorithm typically has a transformer-type architecture. The artificial intelligence algorithm is, for example, a neural network, receiving the social network data D as input and delivering the user model M as output.

In a preliminary learning phase, also known as the training phase, the artificial intelligence algorithm is trained with training data comprising, for each set of training data, training social network data D as input to said algorithm and a corresponding training user model M as output from said algorithm. During this learning process, the adaptation of the parameters of the artificial intelligence algorithm, such as the synaptic weights of the neural network, is carried out via gradient backpropagation, for example, and the parameters of the artificial intelligence algorithm are then adapted based on the gradient of an error between a predicted user model and a target user model.

The transmission module 19 is configured to transmit the user model M to at least one of the on-board electronic equipment items 5, 7 and 9, with a view to the performance of an action dependent on the user model M by the on-board electronic equipment item 5, 7 or 9, as will be explained in the remainder of the description.

In the example shown in FIG. 1, the electronic personalization device 3 is made in the form of an information processing unit formed for example by a memory 21 and a processor 23 associated with the memory 21.

In the example shown in FIG. 1, the acquisition module 15, the building module 17 and the transmission module 19 are each made in the form of software, or a software brick, executable by the processor 23. The memory 21 of the electronic personalization device 3 is then able to store acquisition software, building software and transmission software. The processor 23 is then able to execute each of the acquisition software, the building software and the transmission software.

Advantageously, the user model M is stored in the memory 21, intended to be located only in the vehicle 1.

Advantageously, the memory 21 stores different user models M, each user model M corresponding to a respective user of the vehicle 1.

In a variant which is not shown, the acquisition module 15, the building module 17 and the transmission module 19 each take the form of a programmable logic component, such as an FPGA (Field Programmable Gate Array), or the form of a dedicated integrated circuit, such as an ASIC (Application Specific Integrated Circuit).

When the electronic personalization device 3 is implemented in the form of one or more software programs, that is, in the form of a computer program, it can further be recorded on a computer-readable medium (not shown). The computer-readable medium is, for example, a medium able to store electronic instructions and to be coupled to a bus of a computer system. As an example, the readable medium is an optical disc, a magneto-optical disc, a ROM memory, a RAM memory, any type of non-volatile memory (for example EPROM, EEPROM, FLASH, NVRAM), a magnetic card or an optical card. A computer program containing software instructions is then stored on the readable medium.

The on-board electronic devices 5, 7 and 9 each comprise an interface for receiving the user model M from the electronic personalization device 3, in particular from the transmission module 19, and are configured to implement an action depending on the user model M received.

The cockpit domain controller 5 is configured, for example, to control the infotainment functions of the vehicle 1. Depending on the user model M, the cockpit domain controller 5 anticipates the user's destinations or travel habits, for example, and proposes routes corresponding to these habits, thereby reducing the driver's mental load for route management. Advantageously, the cockpit domain controller 5 selects a recharging or maintenance location for the vehicle 1 and recommends it to the user based on the user's consumption habits, thus helping to anticipate breakdowns. The cockpit domain controller 5 is also able to suggest personalized entertainment content to a passenger user, helping to limit distractions for the driver. According to another example, if the user model M has been trained on social network data D showing that the user does not listen to music when driving or over a specific time slot, the cockpit domain controller 5 deactivates music recommendations when the vehicle 1 is in motion or over the time slots, respectively, so as not to distract the driver, and to thus limit an accident risk.

The equipment controller 7 is configured to control the activation of one or more other items of equipment, such as headlights or windshield wipers. By virtue of the user model M, this control is adapted to the user's habits, for example, which reduces the driver's cognitive load when driving, and thus improves safety on board the vehicle 1, since the driver can focus his attention more on driving the vehicle 1.

The emotion(s) detector 9 is configured to detect at least one user emotion using a context provided by the user model M and to generate a control signal for another equipment item based on the detected emotion. The emotion(s) detector 9 is generally used to secure the vehicle 1, for example by detecting an event generating an emotion of surprise, but currently suffers from emotion interpretation errors caused by a lack of context. This limitation can be overcome by using the user model M.

In a variant which is not shown, the on-board equipment items 5, 7 and 9 can be any other type of on-board electronic equipment item performing at least one action dependent on the user model M.

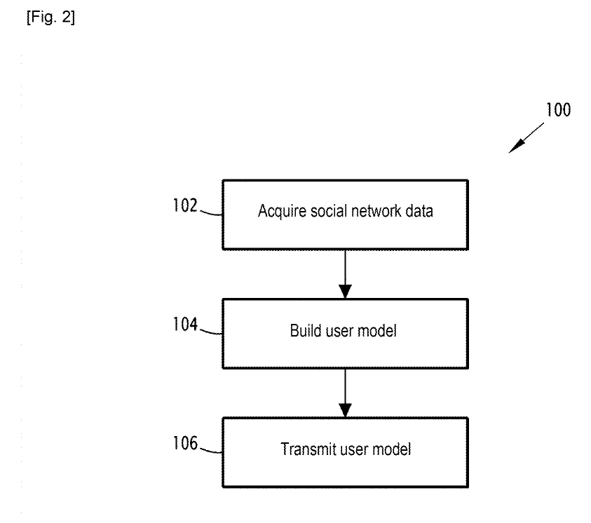

A personalization method 100, implemented by the electronic personalization device 3, is shown in FIG. 2, and comprises an acquisition step 102, a building step 104 and a transmission step 106.

The acquisition step 102 is implemented by the acquisition module 15, and consists in acquiring, from the cockpit domain controller 5, the social network data D associated with a respective user.

The building step 104 is implemented by the building module 15, and consists in building the user model M from the social network data D. The building step 104 is preferably carried out by the artificial intelligence algorithm, which advantageously features a transformer-type architecture. Advantageously, the building step 104 comprises determining the user's social group.

The transmission step 106 is implemented by the transmission module 19, and consists in transmitting the user model M to at least one of the on-board electronic equipment items 5, 7 and 9, with a view to the performance of an action dependent on the user model M by the on-board electronic equipment item 5, 7 or 9.

It is thus conceivable that the electronic personalization device 3 and the personalization method according to the invention make it possible to improve safety on board the motor vehicle 1, in particular by reducing the cognitive load for the driver of the motor vehicle 1, who can then focus more on driving the vehicle 1.

1. A personalization method for a motor vehicle, implemented by an electronic personalization device for the motor vehicle intended to be carried on board the motor vehicle, the vehicle comprising a cockpit domain controller configured to identify a user of the vehicle, connect to an item of user equipment, and collect social network data from the user, the method comprising:
acquiring, via the cockpit domain controller, social network data associated with a user;
building a model of a user profile, known as a user model, from the social network data associated with said user; and
transmitting the user model to at least one item of on-board electronic equipment in the vehicle, so that the on-board electronic equipment can perform an action dependent on the user model.

2. The method according to claim 1, wherein the social network data comprise one or more data from the group consisting of:
a list of social networks frequently used by the user;
a history of actions carried out by the user on each social network;
keywords associated with content consulted by the user on each social network;
a history of the user's usage time ranges of each social network;
a language for using at least one social network; and
user location when using at least one social network.

3. The method according to claim 1, wherein the user model does not contain social network data and is stored in a memory intended for use in the vehicle only.

4. The method according to claim 1, wherein the building step is carried out using an artificial intelligence algorithm.

5. The method according to claim 4, wherein the artificial intelligence algorithm has a transformer-type architecture.

6. The method according to claim 1, wherein the building step includes determining a social group of the user based on social network data and data fusion recommendations from the relevant social networks.

7. A non-transitory computer-readable medium storing instructions which, when executed by one or more processors, cause the one or more processors to perform a personalization method according to claim 1.

8. An electronic personalization device for a motor vehicle, intended to be carried on board the motor vehicle, the vehicle comprising a cockpit domain controller configured to identify a user of the vehicle, connect to an item of user equipment and collect social network data from the user, the electronic device comprising:
a module for the cockpit domain controller to acquire social network data associated with a respective user;
a module for building a model of a user profile, known as a user model, from the social network data associated with said user; and
a module for transmitting the user model to at least one item of on-board electronic equipment in the vehicle, so that the on-board electronic equipment can perform an action dependent on the user model.

9. An assembly comprising:
a cockpit domain controller configured to identify a user, connect to an item of user equipment and collect the social network data of the user;
an electronic personalization device according to claim 8; and
at least one item of on-board electronic equipment, configured to receive the user model transmitted by the electronic personalization device and to implement an action dependent on said user model.

10. The assembly according to claim 9, wherein the at least one item of on-board equipment is selected from the group including:
the cockpit domain controller, configured to deliver information or a recommendation to the user relating to driving the vehicle or using an on-board equipment item, depending on the user model;
an equipment controller configured to control the activation of one or more other items of equipment, such as headlights or windshield wipers; and
an emotion(s) detector, configured to detect at least one user emotion using a context provided by the user model and to generate a control signal for another equipment item based on the detected emotion.
